(19) United States
(12) Patent Application Publication
(10) Pub. No.: US 2021/0045387 A1
(43) Pub. Date: Feb. 18, 2021

(54) COMPOSITIONS AND METHODS TO INHIBIT ARTHROPOD HOST-SEEKING BEHAVIOR

(71) Applicant: The Rockefeller University, New York, NY (US)

(72) Inventors: Leslie VOSSHALL, New York, NY (US); Laura B. DUVALL, New York, NY (US)

(73) Assignee: The Rockefeller University, New York, NY (US)

(21) Appl. No.: 16/993,809

(22) Filed: Aug. 14, 2020

Related U.S. Application Data
(60) Provisional application No. 62/887,302, filed on Aug. 15, 2019.

(51) Int. Cl. A01N 43/78; A01N 43/42; A01N 43/38; A01N 43/54

(52) U.S. Cl. CPC A01N 43/78; A01N 43/54; A01N 43/38; A01N 43/42

(57) ABSTRACT

The present invention generally relates to compositions and methods for inhibiting host-seeking behavior, blood-feeding, and biting in blood-feeding arthropods. The present invention also generally relates to compositions and methods for inhibiting the attraction of blood-feeding arthropods to a host. More particularly, the present invention relates to compositions and methods for inhibiting the host-seeking behavior and biting of mosquitos and inhibiting their attraction to humans.

### GOVERNMENT RIGHTS STATEMENT

This invention was made with U.S. Government support under UL1 TR000043 awarded by National Center for Advancing Translational Sciences (NCATS, National Institutes of Health (NIH) Clinical and Translational Science Award (CTSA) program) and under DC014247 awarded by National Institute on Deafness and Other Communication Disorders (NIDCD, National Institutes of Health (NIH)). The U.S. Government has certain rights in the invention.

### BACKGROUND OF THE INVENTION

### Technical Field

The present invention generally relates to compositions and methods for inhibiting host-seeking behavior and biting in arthropods. More particularly, the present invention relates to compositions and methods for inhibiting the host-seeking behavior and biting of mosquitoes.

### Background Information

Mosquitoes and other arthropods present an important public health threat by virtue of their ability to act as vectors for various diseases infectious to humans and other animals. Diseases such as malaria, dengue, yellow fever, Zika, and chikungunya are transmitted to humans by mosquitoes (Aedes aegypti). The World Health Organization reports that malaria alone was responsible for over 438,000 deaths worldwide in 2015.

Ae. aegypti mosquitoes require blood from a host to complete their full reproductive life cycle. Proteins from blood trigger and sustain egg maturation, and female mosquitoes of this species that fail to obtain a blood-meal do not reproduce. Importantly, a single female will go through multiple blood-feeding and egg-laying cycles in her lifetime. This cycling behavior makes mosquitoes particularly effective disease vectors: when they bite infected humans, disease-causing viral pathogens are passed to the mosquito, and each subsequent bite puts the next human host at risk for infection with these pathogens. Preventing mosquitoes from biting humans is an important point of intervention in global public health strategy.

Various approaches for preventing mosquito-biting behavior have been utilized, including mosquito netting, insect repellents, and eradication methods via chemical or biological insecticides and genetically-modified mosquitoes. These approaches, however, have not been completely successful and may present safety concerns to humans, other living organisms, and/or the environment.

Thus, a need exists for a safe and effective method to prevent mosquitoes from biting humans and other animals to inhibit the spread of vector-borne diseases.

### SUMMARY OF THE INVENTION

The present invention provides, in a first aspect, an arthropod behavior-modulation composition comprising a solvent and a compound of formula I:

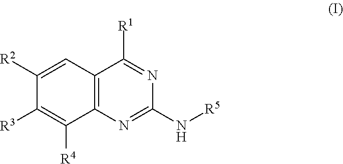

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a second aspect, an arthropod behavior-modulation composition comprising a solvent and a compound selected from:

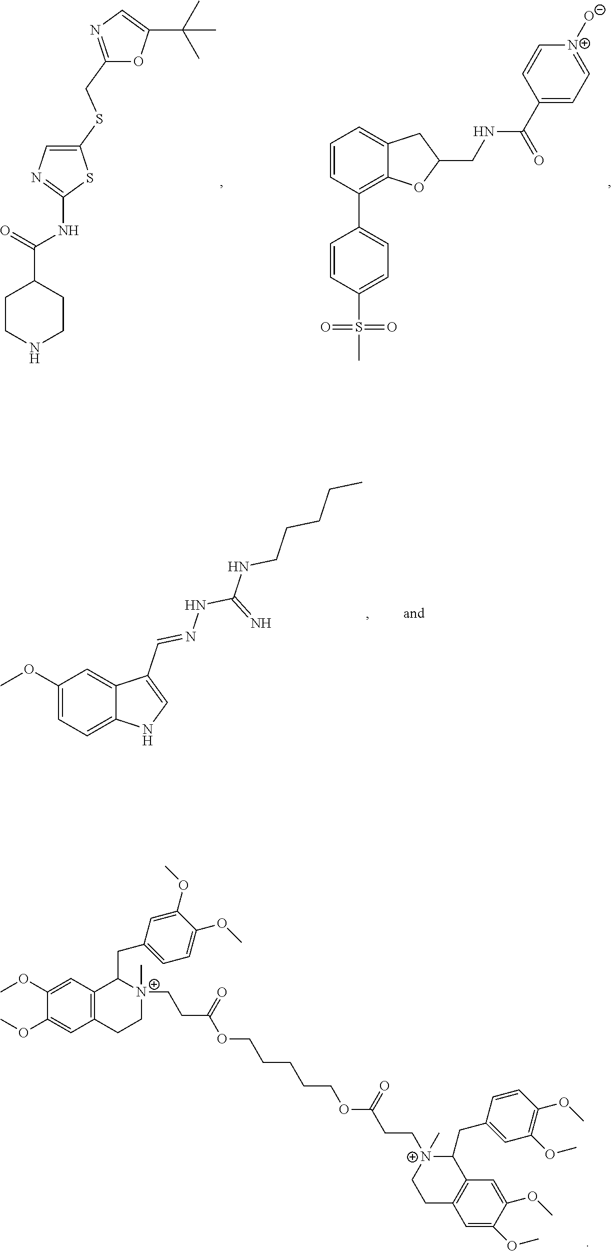

The present invention provides, in a third aspect, a method for disrupting host-seeking behavior in a blood-feeding arthropod, comprising providing an effective amount of a compound to said blood-feeding arthropod, wherein said compound is a compound of formula (I):

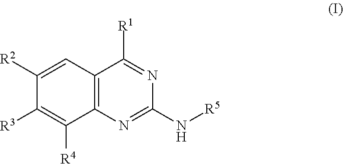

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a fourth aspect, a method for disrupting host-seeking behavior in a blood-feeding arthropod, comprising providing an effective amount of a compound to said blood-feeding arthropod, wherein said compound is selected from:

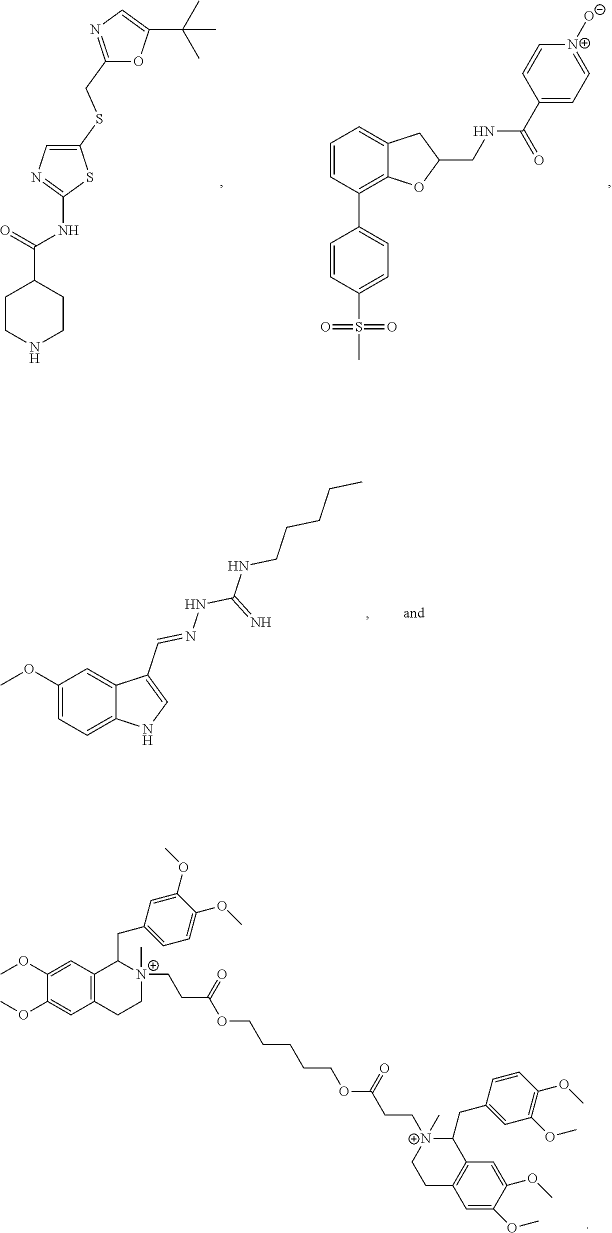

The present invention provides, in a fifth aspect, a method for suppressing host-blood feeding in a blood-feeding arthropod, comprising providing an effective amount of a compound to said blood-feeding arthropod, wherein said compound is a compound of formula (I):

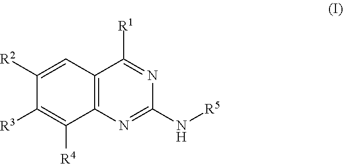

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a sixth aspect, a method for suppressing host-blood feeding in a blood-feeding arthropod, comprising providing an effective amount of a compound to said blood-feeding arthropod, wherein said compound is selected from:

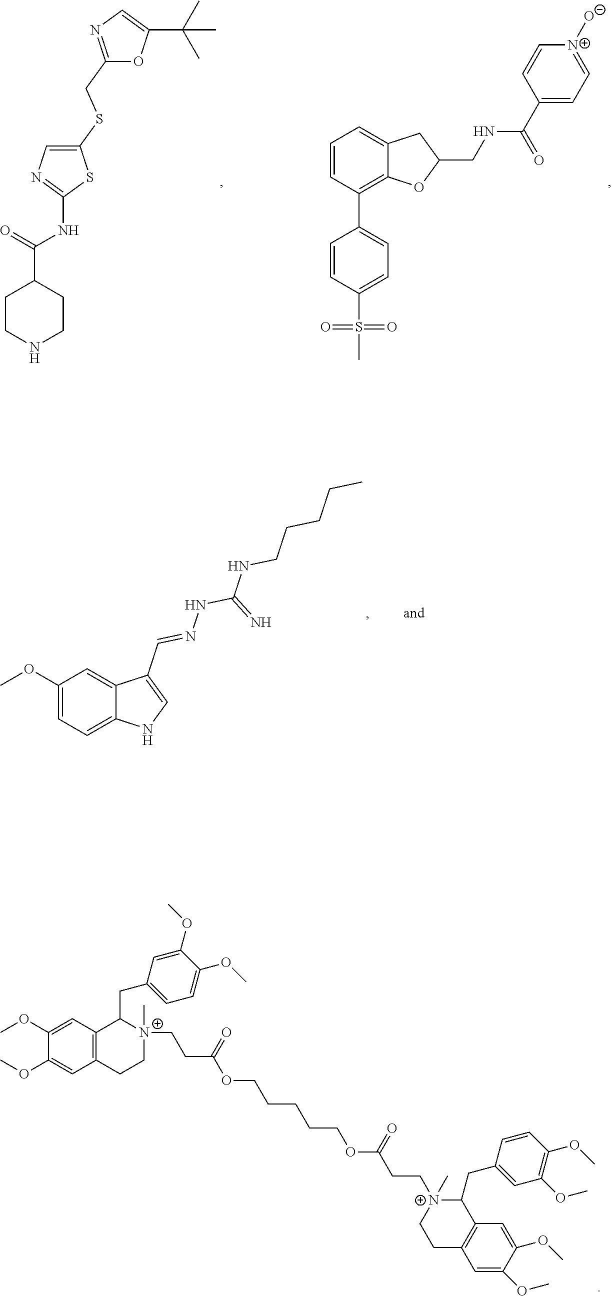

The present invention provides, in a seventh aspect, a method for suppressing host biting by a blood-feeding arthropod, comprising providing an effective amount of a compound to said blood-feeding arthropod, wherein said compound is a compound of formula (I):

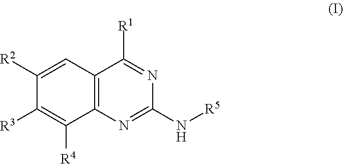

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in an eighth aspect, a method for suppressing host biting by a blood-feeding arthropod, comprising providing an effective amount of a compound to said blood-feeding arthropod, wherein said compound is selected from:

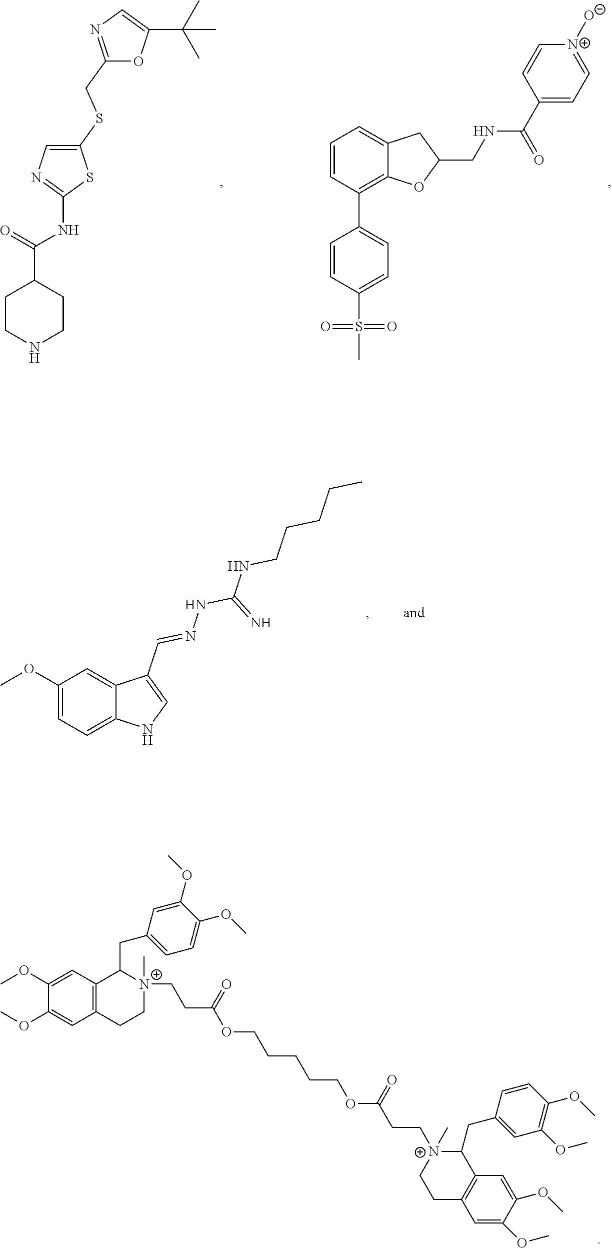

The present invention provides, in a ninth aspect, a method for inhibiting blood-feeding arthropod attraction to humans, comprising providing an effective amount of a compound to said blood-feeding arthropod, wherein said compound is a compound of formula (I):

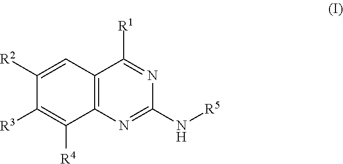

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a tenth aspect, a method for inhibiting blood-feeding arthropod attraction to humans, comprising providing an effective amount of a compound to said blood-feeding arthropod, wherein said compound is selected from:

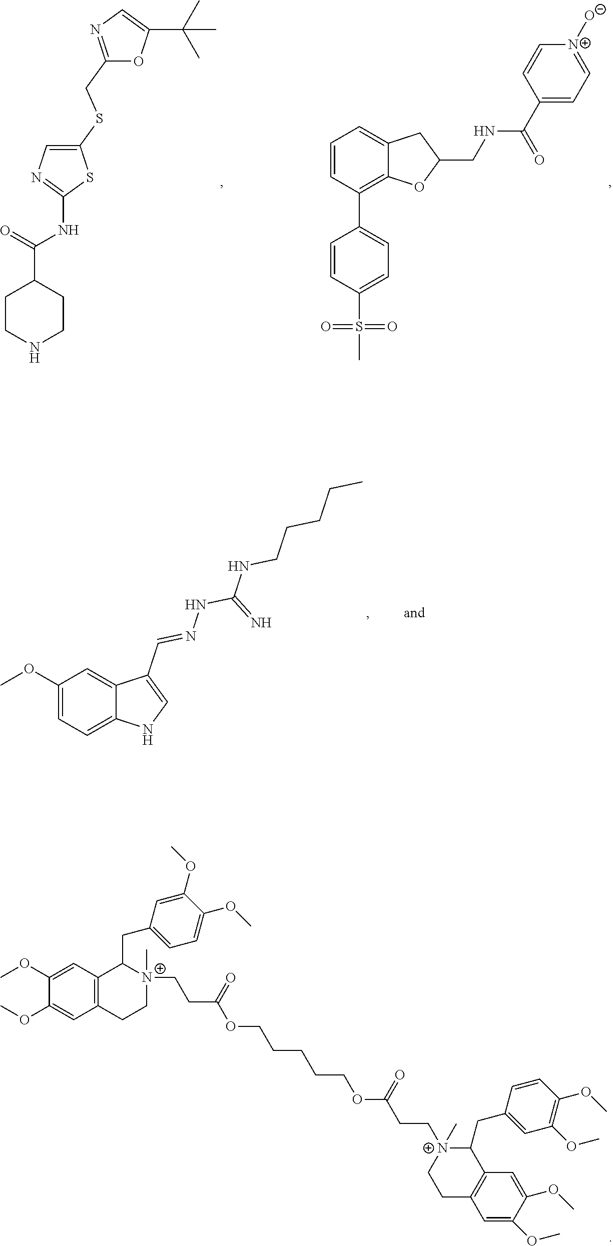

The present invention provides, in an eleventh aspect, an arthropod bait, wherein said bait comprises an effective amount of a compound of formula I:

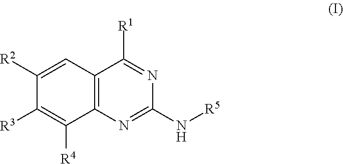

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a twelfth aspect, an arthropod bait, wherein said bait comprises an effective amount of a compound selected from:

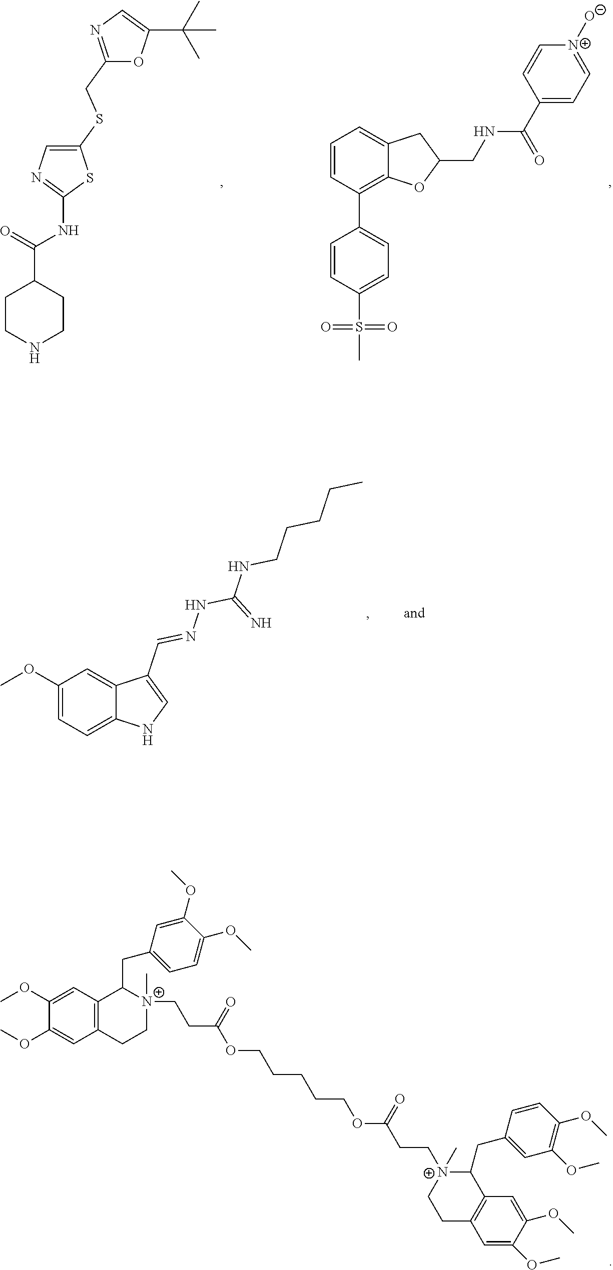

The present invention provides, in a thirteenth aspect, a topical composition comprising a vehicle for topical application and a compound of formula I:

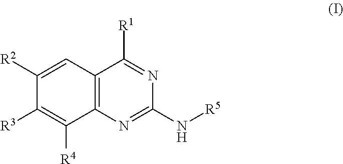

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a fourteenth aspect, a topical composition comprising a vehicle for topical application and a compound selected from:

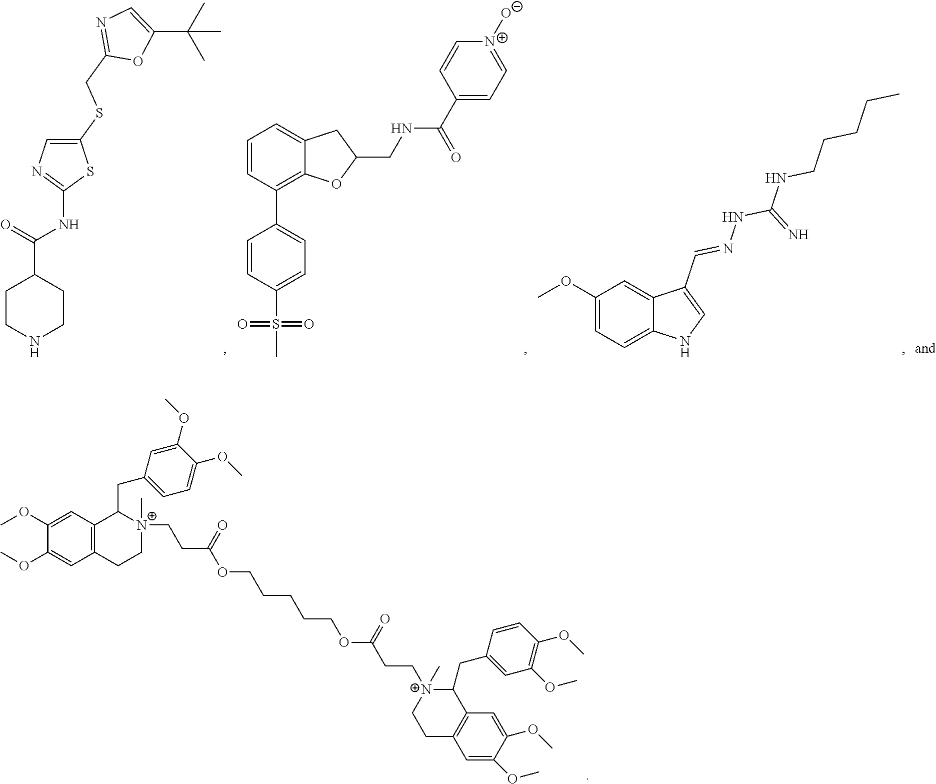

The present invention provides, in a fifteenth aspect, a composition selective for NPY-like receptor 7 (NPYLR7), wherein said compound activates NPY-like receptor 7 (NPYLR7) in an arthropod, but does not activate human NPY receptors, and wherein said composition comprises a solvent and an effective amount of a compound of formula I:

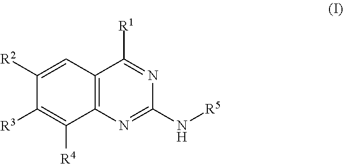

wherein

R¹ is (C₁-C₄)alkyl;

R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;

R⁴ is selected from hydrogen and methyl;

R⁵ is selected from hydrogen, —C(═NH)NH₂, and —C(═NH)NHR⁶; and

R⁶ is (C₁-C₄)alkyl;

with the proviso that at least one of R², R³, and R⁴ is other than hydrogen.

The present invention provides, in a sixteenth aspect, a composition selective for NPY-like receptor 7 (NPYLR7), wherein said compound activates NPY-like receptor 7 (NPYLR7) in an arthropod, but does not activate human NPY receptors, and wherein said composition comprises a solvent and an effective amount of a compound selected from:

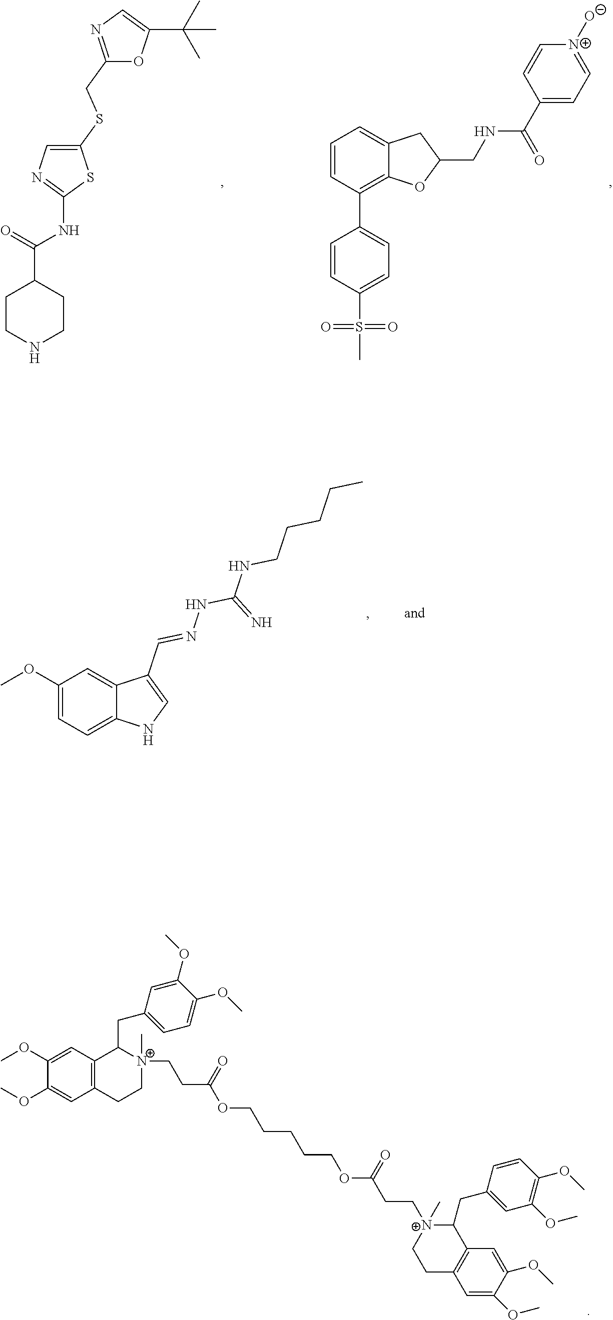

The present invention provides, in a seventeenth aspect, a method of using an NPY agonist to inhibit host-seeking behavior in an arthropod.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 shows a schematic of a miniport olfactometer (mosquitoes not drawn to scale).

FIG. 2 illustrates the level of activation of related NPY-like receptors from a variety of organisms by Ae. aegypti NPYLR7 agonists.

FIG. 3 shows in vivo host-seeking in a miniport olfactometer two days after feeding the indicated meals (n=4-82, 15-25 females/trial).

FIG. 4 depicts A) Schematic of live host assay experiment; and B) Percentage of females (fed the indicated meal two days prior to the experiment) that freshly bloodfed on an anesthetized mouse after a 15-min exposure (median with range; n=5-24, 58-62 females/trial). Data labeled with different letters are significantly different from each other (Kruskal-Wallis test with Dunn's multiple comparison, p<0.05).

FIG. 5 shows that feeding a compound of the invention suppresses host-seeking in Aedes albopictus mosquitoes.

### DETAILED DESCRIPTION OF THE INVENTION

Although female Ae. aegypti mosquitoes are strongly attracted to human hosts when they seek a blood-meal, this attraction is potently inhibited for several days after a complete blood-meal, a period when they digest the blood and mature their eggs. Host-seeking suppression consists of at least two phases: a short-term phase likely involving abdominal distension from a blood-meal that doubles the female's body weight, and a long-term sustained phase that lasts until the female lays her eggs. The mechanisms that maintain sustained host-seeking suppression following clearance of the blood-meal during egg development are unknown.

Without being held to any one theory, it is proposed that after blood-feeding, NPY-like receptor activation leads to sustained host-seeking suppression, which is analogous to a form of long-term satiety. Although the exact peptide and receptor combination remains unknown, NPY-related signaling pathways mediated by other peptides and receptors are strong candidates for controlling this behavior because they are key regulators of motivated feeding behavior and satiety across species. NPY-related signaling pathways are deeply evolutionarily conserved and have been implicated in foraging and motivated feeding behavior in organisms including nematodes, mice, rats, and humans. In both vertebrates and invertebrates, there is extensive cross-talk between multiple NPY-like peptides and NPY receptors, with each peptide activating multiple receptors, and a given receptor responding to more than one peptide. For instance, humans have four NPY receptors, and their activation has heterogeneous effects on food intake depending upon the specifics of peptide/receptor pairing. Invertebrate NPY-like receptors show roughly 60% sequence similarity to vertebrate NPY Y2 receptors. Consistent with their evolutionary conservation, small molecule and peptide drugs designed to target human neuropeptide receptors are also capable of acting on insect receptors.

A number of compounds, when fed at micromolar doses, are disclosed herein that inhibit host-seeking, biting, and blood-feeding when mosquitoes are offered a live host. These behaviors are the first step in mosquito-borne disease transmission, and exploiting this host-seeking suppression represents a new strategy for the control of disease-vectoring mosquitoes. These compounds are very selective agonists of NPYLR7 with minimal activation of other Ae. aegypti receptors or human NPY receptors. Feeding small molecule NPYLR7 agonists to female mosquitoes is sufficient to prevent host-seeking, biting, and blood-feeding behavior, raising the possibility that field application of these compounds could reduce disease transmission by inhibiting the drive of mosquitoes to seek humans. These compounds could be delivered in baited attraction traps using stimuli that mimic host-associated cues including human body odor and carbon dioxide, or in the seminal fluid of transgenic males. Delivering these compounds in traps baited with human odor also ensures that beneficial insects are not targeted by these methods.

The pattern of active host-seeking followed by host-seeking suppression after a blood meal is observed widely in blood-feeding arthropods including other mosquito species and ticks, and members of the NPY-like receptor family are found in the genomes of these organisms. It is expected that the compounds identified herein will show efficacy in additional disease vectors. Exploiting the female mosquito's endogenous regulation of her own host-seeking behavior represents a novel strategy to prevent the spread of vector-borne disease and may have broad applications across blood-feeding arthropods that spread disease to hundreds of millions of people each year.

Herein, when a claim refers to “a compound of formula I,” the claim includes any compound included in the formula I genus and definitions. It can be in the context of a method, a composition, a topical composition, or a bait. As a non-limiting example, even though a compound may not be specifically listed in a claim or an embodiment, a topical composition may comprise a vehicle for topical application and, for instance,

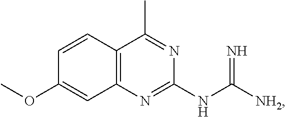 [SMILES: COc1ccc2c(C)nc(NC(=N)N)nc2c1]

which is included as a compound of formula I.

In some embodiments in which the compound is a compound of formula I, R¹ is (C₁-C₄)alkyl. In some embodiments, R¹ is methyl, ethyl, propyl, or butyl. In other embodiments R¹ is methyl or ethyl. In yet other embodiments R¹ is methyl. In still other embodiments R¹ is ethyl.

In some embodiments in which the compound is a compound of formula I, R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino. In other embodiments, R² is selected from hydrogen, (C₁-C₄)alkyl, and (C₁-C₄)alkoxy. In some embodiments, R² is selected from hydrogen, methoxy, ethoxy, methyl, ethyl, fluoro, and chloro. In other embodiments, R² is selected from hydrogen, methoxy, methyl, ethyl, or ethoxy. In yet other embodiments, R² is hydrogen. In some embodiments, R² is methoxy. In some embodiments, R² is ethoxy.

In some embodiments in which the compound is a compound of formula I, R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino. In other embodiments, R³ is selected from hydrogen, (C₁-C₄)alkyl, and (C₁-C₄)alkoxy. In some embodiments, R³ is selected from hydrogen, methoxy, ethoxy, methyl, ethyl, fluoro, and chloro. In other embodiments, R³ is selected from hydrogen, methoxy, methyl, ethyl, or ethoxy. In yet other embodiments, R³ is hydrogen. In some embodiments, R³ is methoxy. In some embodiments, R³ is ethoxy.

In some embodiments in which the compound is a compound of formula I, R⁴ is selected from hydrogen and methyl. In other embodiments, R⁴ is hydrogen. In some embodiments, R⁴ is methyl.

In some embodiments in which the compound is a compound of formula I, R⁵ is selected from hydrogen, —C(═NH)NH₂, and —C(═NH)NHR⁶. In some embodiments, R⁵ is hydrogen. In other embodiments, R⁵ is —C(═NH)NH₂. In still other embodiments, R⁵ is —C(═NH)NHR⁶.

In some embodiments in which the compound is a compound of formula I, R⁶ is (C₁-C₄)alkyl. In some embodiments, R⁶ is methyl. In some embodiments, R⁶ is ethyl.

In some embodiments in which the compound is a compound of formula I, one of R² and R³ is (C₁-C₄)alkoxy or (C₁-C₄)alkyl, and the other is hydrogen. In other embodiments, R² is selected from methoxy, ethoxy, and methyl, and R³ is hydrogen. In still other embodiments in which the compound is a compound of formula I, R³ is selected from methoxy, ethoxy, and methyl, and R² is hydrogen. In yet other embodiments, one of R² and R³ is methoxy, and the other is hydrogen. In some embodiments, one of R² and R³ is —CH₃, and the other is hydrogen.

In some embodiments in which the compound is a compound of formula I, R⁴ is methyl and both R² and R³ are hydrogen.

In some embodiments in which the compound is a compound of formula I, R⁵ is —C(═NH)NH₂ and R² is hydrogen.

In some embodiments in which the compound is a compound of formula I, R¹ is methyl or ethyl; R² is hydrogen, (C₁-C₄)alkoxy, or (C₁-C₄)alkyl; R³ is hydrogen, (C₁-C₄)alkoxy, or (C₁-C₄)alkyl; R⁴ is hydrogen or methyl; and R¹ is selected from hydrogen and —C(═NH)NH₂.

In some embodiments in which the compound is a compound of formula I, R¹ is methyl or ethyl; R² is hydrogen, —CH₃, —OCH₃, or —OCH₂CH₃; R³ is hydrogen, —CH₃, —OCH₃, or —OCH₂CH₃; and R⁴ is hydrogen or methyl.

In some embodiments in which the compound is a compound of formula I, the compound is selected from:

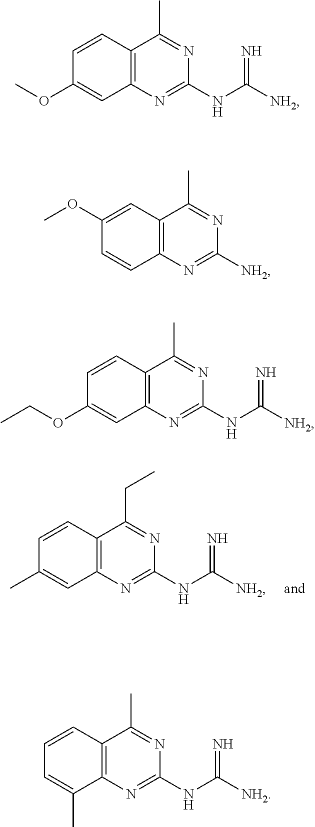 [SMILES: COc1ccc2c(C)nc(NC(=N)N)nc2c1 ; COc1ccc2nc(N)nc(C)c2c1 ; CCOc1ccc2c(C)nc(NC(=N)N)nc2c1 ; CCc1nc(NC(=N)N)nc2cc(C)ccc12 ; "and" ; Cc1nc(NC(=N)N)nc2c(C)cccc12]

In other embodiments in which the compound is a compound of formula I, the compound is

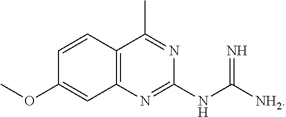 [SMILES: COc1ccc2c(C)nc(NC(=N)N)nc2c1]

In other embodiments in which the compound is a compound of formula I, the compound is

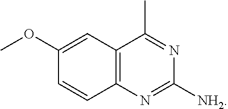

In still other embodiments in which the compound is a compound of formula I, the compound is

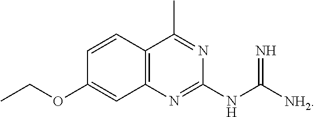 [SMILES: CCOc1ccc2c(C)nc(NC(=N)N)nc2c1]

In yet other embodiments in which the compound is a compound of formula I, the compound is

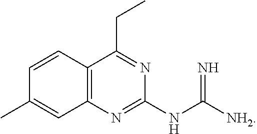 [SMILES: CCc1nc(NC(=N)N)nc2cc(C)ccc12]

In some embodiments in which the compound is a compound of formula I, the compound is

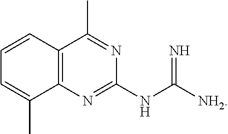 [SMILES: Cc1nc(NC(=N)N)nc2c(C)cccc12]

In some embodiments, the invention relates to a method for disrupting host-seeking behavior in a blood-feeding arthropod by providing to the blood-feeding arthropod a compound described herein.

In some embodiments, the invention relates to a method for suppressing host-blood feeding in a blood-feeding arthropod by providing to the blood-feeding arthropod a compound described herein.

In some embodiments, the invention relates to a method for suppressing host biting by a blood-feeding arthropod in a blood-feeding arthropod by providing to the blood-feeding arthropod a compound described herein.

In some embodiments, the invention relates to a method for inhibiting the attraction of a blood-feeding arthropod to a host by providing to the blood-feeding arthropod a compound described herein.

In still other embodiments, the host is a vertebrate. In some embodiments, the host is a human. In still other embodiments, the host is a mammal. In yet other embodiments, the host is a livestock animal, such as a cow or a horse. In other embodiments, the host is a bird. In some embodiments, the host is a reptile.

In some embodiments, the invention relates to an arthropod bait, wherein the bait comprises a compound described herein.

In one aspect, the invention relates to a topical composition. The composition includes a vehicle for topical application and a compound described herein. This topical composition may be applied to the skin, hair, fur, or feathers, or to the clothing or other external covering of an animal, including a human.

In one aspect, the invention relates to an arthropod behavior-modulation composition. The composition includes a compound described herein and a solvent appropriate for the environmental and/or application conditions.

In one aspect, the invention relates to a composition selective for NPY-like receptor 7 (NPYLR7). The composition includes a solvent and an effective amount of a compound described herein; the compound activates NPY-like receptor 7 (NPYLR7) in an arthropod, but does not activate human NPY receptors.

The term “solvent,” for purposes of this disclosure, refers to a carrier that can deliver the compounds disclosed herein to be available to blood-feeding arthropods. In some embodiments, the solvent is a liquid carrier. These liquid carriers can be simple solutions such as saline, feeding solutions, or blood. In some embodiments, the solvent is saline. In other embodiments, the saline contains sodium bicarbonate and ATP. In still other embodiments, the saline is protein-free saline. In other embodiments, the solvent is an arthropod food source. In yet other embodiments, the solvent is blood. In some embodiments, the solvent is animal blood, for instance, the blood of humans and/or sheep. In other embodiments, the blood is artificial blood. Artificial blood may be a protein-rich meal comprised of, for instance, purified albumin (for instance, human albumin), γ-globulins, hemoglobin, and ATP in sodium bicarbonate. In some embodiments, the solvent contains additional components such as insect attractants, pheromones, preservatives, buffers, and/or surfactants. In some embodiments, the solvent is one that is acceptable for solubilizing the compounds disclosed herein while aiding in dispersion of the compounds in desired geographic areas, such as stagnant water sources or jungle areas. In other embodiments, the solvent may be a contained within a delivery system, such as a pellet. In still other embodiments, the solvent and compounds disclosed herein may be aerosolized.

In one embodiment, the solvent comprises one or more of ethanol, dichloromethane, ethyl acetate, hexane, an oil, a non-polar solvent, a surfactant, or a mixture or blend thereof. In another embodiment, the solvent includes a non-toxic, biodegradable solubilizing carrier or surfactant or a mixture or blend thereof.

Methods of delivering a compound of the invention to an arthropod can vary. In some embodiments, the arthropod is a mosquito, and in some cases is a female mosquito. In some embodiments, the compound is delivered internally to an arthropod. In some embodiments, the compound is delivered through ingestion of the compound. In some embodiments, the compound is delivered through a feeding solution and is eaten by the arthropod. In other embodiments, the compound may be delivered to the arthropod by baiting traps with odors (for instance, human odor) to attract the arthropod. In other embodiments, contact with the seminal fluid of a transgenic male may deliver the compound internally to a female. In some embodiments, a compound is delivered internally to an arthropod through the arthropod's respiratory system. For instance, the compound may be aerosolized such that it is in the air and respirated by the arthropod. In other embodiments, the compound may be resident on a surface and get on the arthropod's surface. Non-limiting examples of the method of delivery include field application, soaking, spraying, injecting, feeding, introducing to through an aerosolized disbursement, introducing to through an environmental aerosolized disbursement, introducing to through an environmental aerosolized disbursement in water sources, or brushing, dressing, dripping, or coating the arthropod.

The term “disease” refers to an infectious pathogen including, but not limited to, a bacterium, a virus, or a parasite.

The term “disease vector,” for purposes of this disclosure, refers to an organism that carries an infectious pathogen and transmits it into another living organism. In some embodiments, the disease vector is an arthropod. In some embodiments, the disease vector is a mosquito.

The term “arthropod” as used herein, describes any arthropod species and, in particular, a host-seeking species that can act as a disease vector. Non-limiting examples include mosquitoes, ticks, triatomine bugs, cockroaches, flies, tsetse flies, black flies, sand flies, fleas, mites, lice, midges, wasps, bees, ants, bedbugs, etc. However, the compositions, devices, and methods disclosed herein can also be utilized with other species. Thus, it should be understood that the term “arthropod” or “mosquito” is merely used for convenience and is not meant to imply any limitation regarding the use of the embodiments of the invention. In some embodiments, the arthropod is selected from a mosquito or a tick. In other embodiments, the mosquito is selected from the genus Aedes, Anopheles, or Culex. In still other embodiments, the mosquito is selected from Aedes aegypti, Aedes albopictus, Anopheles gambiae, and Culex quinquefasciatus. In some embodiments the tick is from the genus Ixodes. In other embodiments, the tick is Ixodes scapularis.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

As used herein, and as would be understood by the person of skill in the art, the recitation of “a compound”—unless expressly further limited—is intended to include salts of that compound.

The term “salt” refers to salts prepared from acids or bases, including inorganic acids and bases and organic acids and bases. When the compounds of the present invention are basic, salts may be prepared from acids including inorganic and organic acids. Suitable acid addition salts for the compounds of the present invention include acetic, adipic, alginic, ascorbic, aspartic, benzenesulfonic (besylate), benzoic, boric, butyric, camphoric, camphorsulfonic, carbonic, citric, ethanedisulfonic, ethanesulfonic, ethylenediaminetetraacetic, formic, fumaric, glucoheptonic, gluconic, glutamic, hydrobromic, hydrochloric, hydroiodic, hydroxynaphthoic, isethionic, lactic, lactobionic, laurylsulfonic, maleic, malic, mandelic, methanesulfonic, mucic, naphthylenesulfonic, nitric, oleic, pamoic, pantothenic, phosphoric, pivalic, polygalacturonic, salicylic, stearic, succinic, sulfuric, tannic, tartaric acid, teoclatic, p-toluenesulfonic, and the like. When the compounds contain an acidic side chain, suitable base addition salts for the compounds of the present invention include, but are not limited to, metallic salts made from aluminum, calcium, lithium, magnesium, potassium, sodium and zinc or organic salts made from lysine, arginine, N,N′-dibenzylethylenediamine, chloroprocaine, choline, diethanolamine, ethylenediamine, meglumine (N-methylglucamine) and procaine. Further acceptable salts include, when appropriate, ammonium cations and carboxylate, sulfonate and phosphonate anions attached to alkyl having from 1 to 20 carbon atoms.

Also provided herein is a composition comprising a compound disclosed above, or a salt form thereof, and an acceptable carrier or diluent.

While it may be possible for the compounds of the formulae disclosed herein to be administered as the raw chemical, they may also be presented as compositions. According to a further aspect, the present invention provides a composition comprising a compound of formula I or a salt thereof, together with one or more carriers thereof and optionally one or more other ingredients. The carrier(s) must be “acceptable” in the sense of being compatible with the other ingredients of the formulation.

An “effective” amount of a compound described herein is typically one which is sufficient to achieve a desired effect and may vary according to the nature of the environmental or biological conditions, the arthropod, and/or the potency of the compound. It will be appreciated that different concentrations of a compound may be necessary depending on the vector or the environmental conditions.

Throughout this specification the terms and substituents retain their definitions. Substituents Rⁿ are generally defined when introduced and retain that definition throughout the specification and in all independent claims.

Throughout this specification, a range includes the integers between the lower and higher number, inclusive. For instance, the term “(C₁-C₄)” refers to a moiety that contains between one, two, three, or four carbon atoms. This remains true if the term “(C₁-C₄)” is used in the context of, for instance, “(C₁-C₄)alkyl,” “(C₁-C₄)alkoxy,” “halo(C₁-C₄)alkyl,” or “fluoro(C₁-C₄)alkoxy.”

Alkyl (or alkylene) is intended to include linear or branched saturated hydrocarbon structures and combinations thereof. Unless otherwise specified, alkyl refers to alkyl groups from 1 to 20 carbon atoms, or 1 to 10 carbon atoms, or 1 to 6 carbon atoms, or 1 to 4 carbon atoms. Examples of alkyl groups include methyl, ethyl, propyl, isopropyl, n-butyl, s-butyl, t-butyl and the like. “Propyl” includes n-propyl and isopropyl. “Butyl” includes n-butyl, s-butyl, and t-butyl.

Unless otherwise specified, alkoxy or alkoxyl refers to groups of from 1 to 20 carbon atoms, or 1 to 10 carbon atoms, or 1 to 6 carbon atoms, or 1 to 4 carbon atoms, of a straight or branched configuration attached to the parent structure through an oxygen. Examples include methoxy, ethoxy, propoxy, isopropoxy and the like. Lower-alkoxy refers to groups containing one to four carbons. For the purpose of this application, alkoxy and lower alkoxy include methylenedioxy and ethylenedioxy.

The term “halogen” means fluorine, chlorine, bromine or iodine atoms. In one embodiment, halogen may be a fluorine or chlorine atom.

Table 1 illustrates structures of examples of the invention.

TABLE 1

| Compound | |
|---|---|
| No. | Structure |
| 1 | 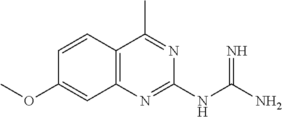 [SMILES: COc1ccc2c(C)nc(NC(=N)N)nc2c1] |
| 2 | 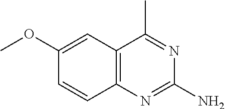 |
| 3 | 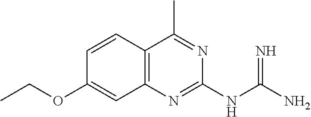 [SMILES: CCOc1ccc2c(C)nc(NC(=N)N)nc2c1] |
| 4 | 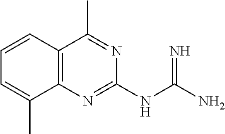 [SMILES: Cc1nc(NC(=N)N)nc2c(C)cccc12] |
| 5 | 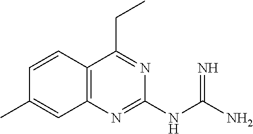 [SMILES: CCc1nc(NC(=N)N)nc2cc(C)ccc12] |
| 6 | 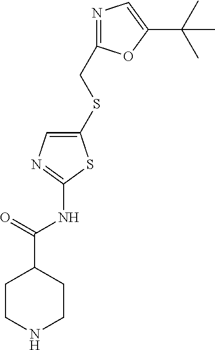 [SMILES: CC(C)(C)c1cnc(CSc2cnc(NC(=O)C3CCNCC3)s2)o1] |
| 7 | 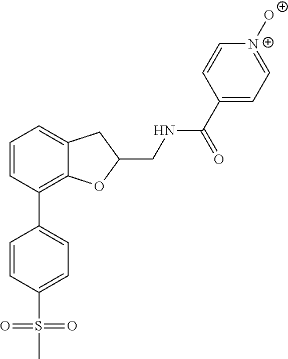 [SMILES: CS(=O)(=O)c1ccc(-c2cccc3c2OC(CNC(=O)c2cc[n+]([OH2+])cc2)C3)cc1] |
| 8 | 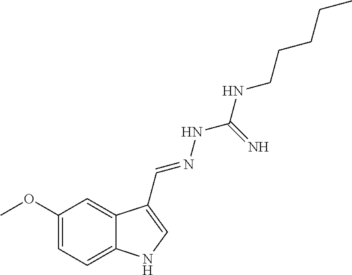 [SMILES: CCCCCNC(=N)N/N=C/c1c[nH]c2ccc(OC)cc12] |
| 9 | 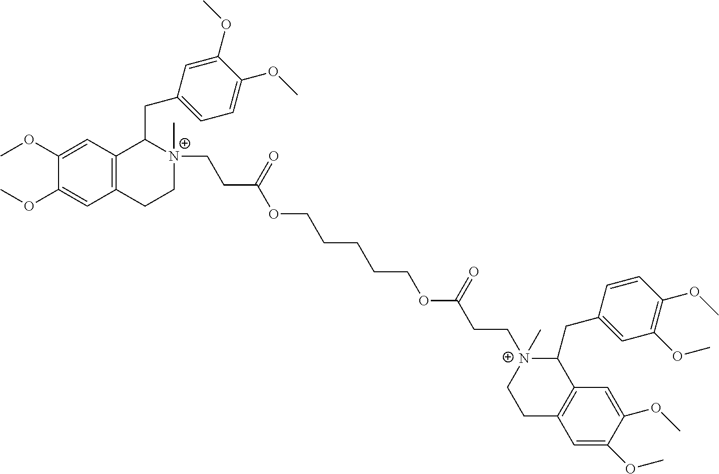 |

### Experimentals

The experimental information, including assay descriptions and sources for reagents and resources, are described in Duvall et al., “Small molecule agonists of Ae. aegypti neuropeptide Y receptor block mosquito biting.” Cell 176, 687-701. This reference is hereby included herein in its entirety.

Small molecule screen identifies NPYLR7 agonists that suppress host-seeking in vivo: TM30335 (a known compound) is a potent agonist of mosquito NPYLR7; however, it also activates human NPY receptors. These off-target effects limit practical applications of this drug as a mosquito behavioral control agent. Selective small molecule agonists of NPYLR7 that do not activate human NPY receptors were identified through a high-throughput screen of small molecules to find selective Ae. aegypti NPYLR7 agonists. 265,211 unique small molecules were screened at a concentration of 10 μM using GCaMP6s activation as a readout of NPYLR7 activation, and 376 compounds were identified that activated cells expressing NPYLR7. These were then counter-screened against non-receptor transfected controls, in an independent cell-based Fura-2 assay, and validated by mass spectrometry. This secondary screen identified 24 compounds that specifically and robustly activate NPYLR7 in vitro.

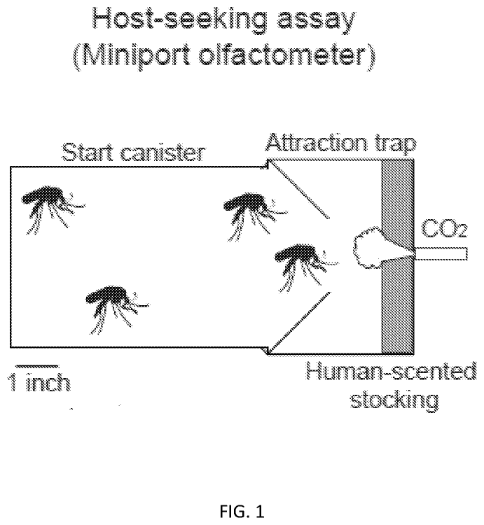

The uniport olfactometer assay (Liesch et al., 2013) quantifies mosquito attraction to the arm of a live human host and carbon dioxide. A related, higher-throughput behavioral assay, the miniport olfactometer, was developed by the inventors, and compounds were screened for an effect on behavioral suppression by feeding them to female mosquitoes via a Glytube. Mosquitoes were fed the 24 individual compounds in protein-free saline, and host-seeking was assayed in the miniport olfactometer two days after feeding to determine if these molecules could suppress host-seeking behavior in vivo (FIG. 1). This behavioral screen identified six small molecule NPYLR7 agonists that suppressed host-seeking behavior in the miniport olfactometer assay.

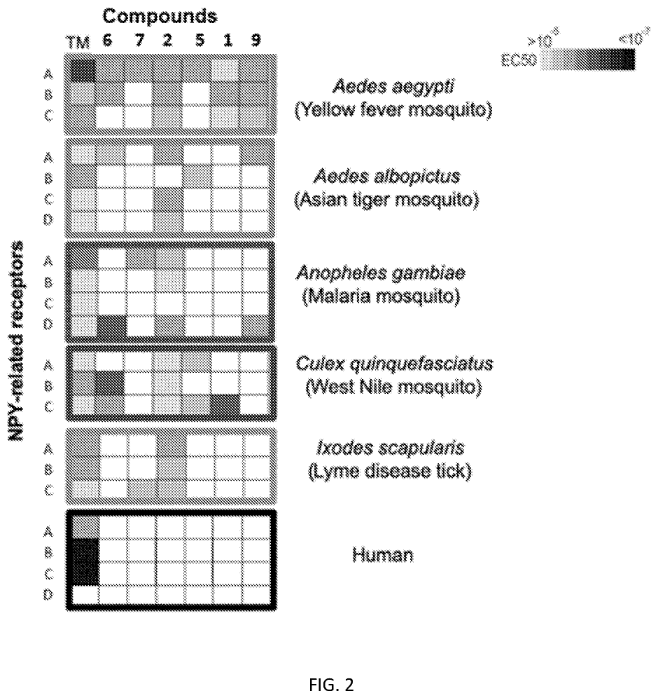

The six compounds were screened in vitro against the panel of all 49 known Ae. aegypti peptide receptors from both L3 and L5 genome annotations, as well as human NPY receptors. FIG. 2 illustrates the level of activation of related NPY-like receptors by Ae. aegypti NPYLR7 agonists in a variety of organisms in a cell-based assay. HEK cells were transfected with receptor cDNA, promiscuous Gα subunit, and GCaMP6s. Activation was read out as increase in GFP fluorescence and EC50 values were calculated on a 6 point dose-response curve (FIG. 2). The vertical axis of each box represents NPY-related receptors for each organism: for instance, Ae. aegypti has three receptors that were tested in this assay, while Ae. Albopictus has four. To be clear, this designation in one species does not necessarily indicate that the receptor itself is conserved between species; that is, the receptor of Row A of Ae. aegypti is not necessarily related to the receptor of Row A of Ae. Albopictus. The horizontal axis indicates the compound tested. “TM” represents TM30335, the agonist of mosquito NPYLR7 that also activates human NPY receptors, as shown by the dark boxes in rows B and C. Compounds 6, 7, 2, 5, 1, and 9 were also tested. As can be seen, while Compounds 6, 7, 2, 5, 1, and 9 activate many of the receptors in non-human organisms, none of these compounds activates any of the human receptors, demonstrating their selectivity. The hits from the small molecule screen are highly selective NPYLR7 agonists that are capable of inhibiting mosquito attraction to human host cues. All six compounds showed high specificity for NPYLR7 in vitro with minimal off-target effects on other mosquito peptide receptors, and these small molecule agonists of NPYLR7 identified in the screen did not activate any human NPY receptors.

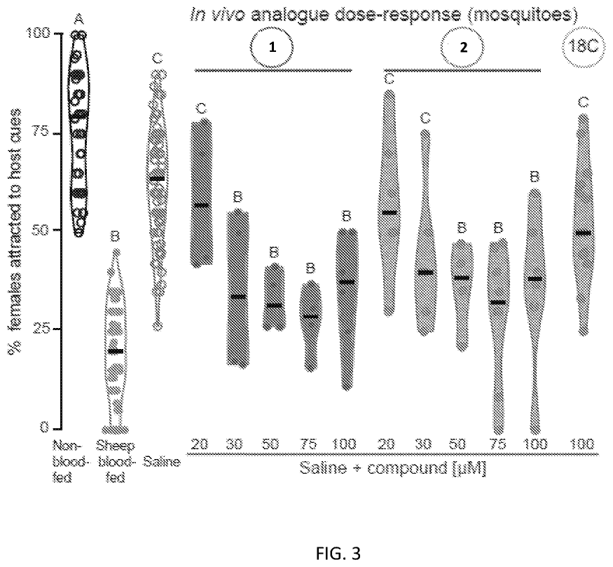

Commercially available analogues of Compound 1 were tested in the in vitro assay to explore the relationship between structure and activity compared to the initial hit. Compound 2 showed similar in vitro and in vivo (FIG. 3) potency to Compound 1, while Compound 18C (structure not shown) was considered inactive. (Compound designations shown as circled numbers.)

NPYLR7 agonists prevent blood-feeding on live hosts in mark-release-recapture experiments: In previous experiments, a miniport olfactometer was used to demonstrate in vivo efficacy of the human NPY receptor drug TM30335 and the small molecule hits described above. These assays measure mosquito attraction to human host cues such as odor and carbon dioxide, but do not give mosquitoes access to bite and blood-feed from a live host. Since biting and blood-feeding are the key behaviors that lead to disease transmission, Compound 1 was tested to determine if it is capable of preventing mosquitoes from approaching, biting, and blood-feeding on a live host.

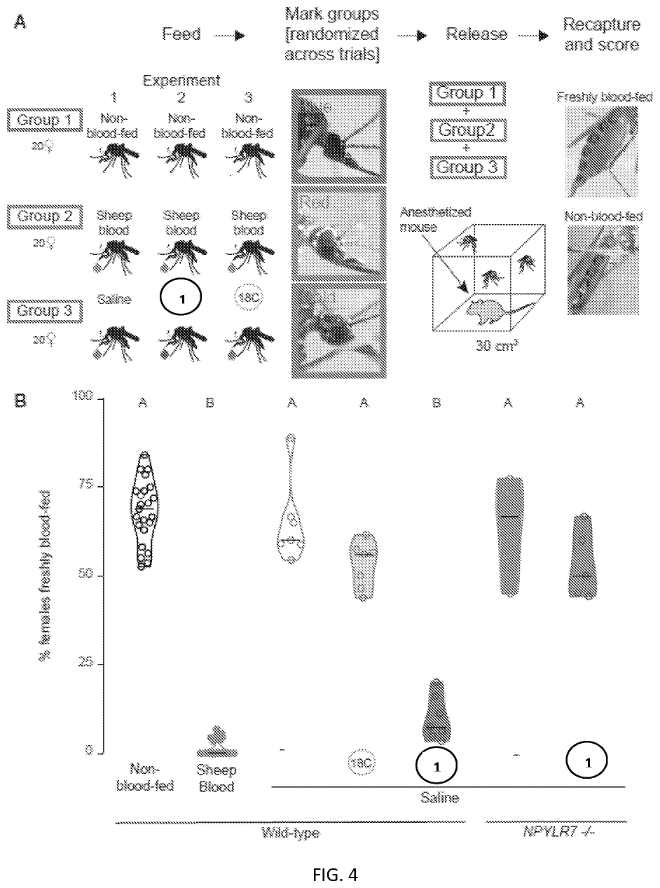

Female mosquitoes were fed either saline alone, or saline with 100 μM of active Compound 1 or an inactive compound and allowed to recover for two days. Females from each feeding group were separately marked with one of three different paint powders using the “shake in a bag” technique (Verhulst et al., 2013), and all three of these groups were pooled and allowed to recover together in a cage. Powder marking was randomized between trials to ensure that each drug treatment/powder marked pairing was used and that powder marking did not directly interfere with the ability host-seek, bite, or blood-feed from a live host. As shown in FIG. 4, after recovery, an anesthetized mouse was placed in the cage and female mosquitoes were given 15 minutes of free access to the mouse before being removed from the cage and scored for blood-feeding (A). Females were scored for powder color to indicate treatment condition and for the presence of fresh blood in the midgut. Similar to the results in host-seeking assays, non-blood-fed and saline-fed females consumed fresh blood at high levels. In contrast, females that had fed on sheep blood two days prior rarely consumed fresh blood. Females fed active Compound 1 also showed very low levels of blood-feeding on a live host, comparable to that seen in females suppressed by a prior blood-meal however NPYLR7 mutants were resistant to this effect (B). Finally, mosquitoes fed an inactive compound (18C) consumed fresh blood at levels comparable to non-fed females or females fed saline. These experiments demonstrate that this selective NPYLR7 agonist is capable of suppressing host-seeking, biting, and blood-feeding on a live host. (Compound designations shown as circled numbers.)

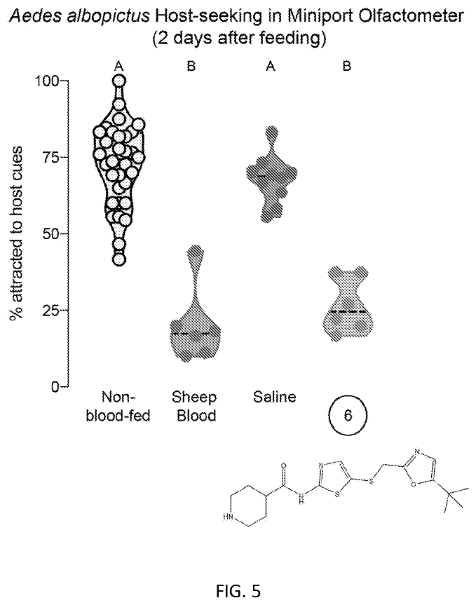

New unpublished data show that feeding Compound 6 suppresses host-seeking in Aedes albopictus mosquitoes (FIG. 5), a species that is related to Aedes aegypti and vectors many of the same disease-causing pathogens. (Compound designation shown as circled number 6.) This compound activates Aedes albopictus NPY-like receptors in vitro (as shown in FIG. 2). This indicates that NPY-like signaling likely mediates attraction to human hosts in multiple species of mosquitoes and suggests that these compounds will show broad efficacy in blocking mosquitoes and ticks from biting humans. Aedes albopictus host-seeking in a miniport olfactometer two days after feeding the indicated meals (n=6-34, 15-25 females/trial) is shown in FIG. 5. Data are plotted as median with range. Data labeled with different letters are significantly different from each other (Kruskal-Wallis test with Dunn's multiple comparison, p<0.05).

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

We claim:

1. A method for:
a) disrupting host-seeking behavior in a blood-feeding arthropod; and/or
b) suppressing host-blood feeding in a blood-feeding arthropod; and/or
c) suppressing host biting by a blood-feeding arthropod; and/or
d) inhibiting the attraction of a blood-feeding arthropod to humans;
comprising providing to said blood-feeding arthropod an effective amount of a compound selected from 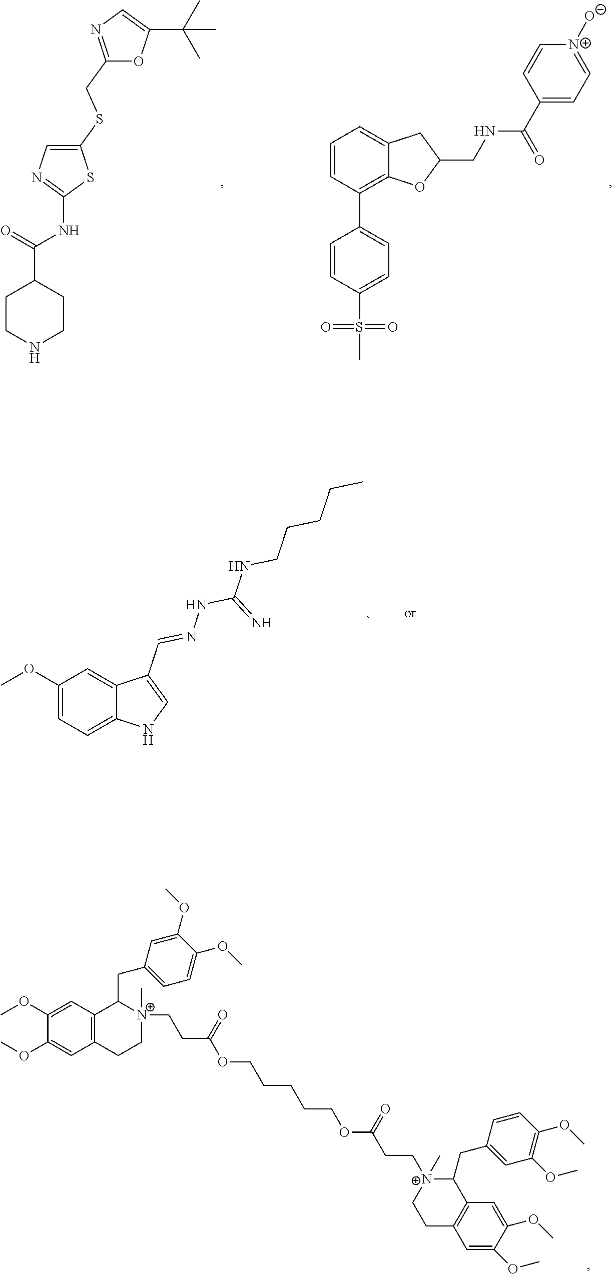
or a compound of formula I: 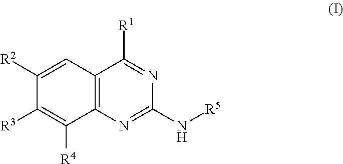
wherein
R¹ is selected from (C₁-C₄)alkyl;
R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;
R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;
R⁴ is selected from hydrogen and methyl;
R⁵ is selected from hydrogen, —C(═NH)NH₂, and —C(═NH)NHR⁶; and
R⁶ is (C₁-C₄)alkyl;
with the proviso that at least one of R², R³, and R⁴ is other than hydrogen.

2-4. (canceled)

5. The method according to claim 1, wherein R¹ is methyl or ethyl.

6. (canceled)

7. The method according to claim 1, wherein R⁵ is —C(═NH)NH₂.

8-9. (canceled)

10. The method according to claim 1, wherein R⁵ is hydrogen.

11. The method according to claim 1, wherein R² is selected from hydrogen, (C₁-C₄)alkyl, and (C₁-C₄)alkoxy.

12. The method according to claim 11, wherein R² is selected from hydrogen, —CH₃, —OCH₃, and —OCH₂CH₃.

13. The method according to claim 1, wherein R³ is selected from hydrogen, (C₁-C₄)alkyl, and (C₁-C₄)alkoxy.

14. The method according to claim 13, wherein R³ is selected from hydrogen, —CH₃, —OCH₃, and —OCH₂CH₃.

15. The method according to claim 1, wherein R⁴ is hydrogen.

16. (canceled)

17. The method according to claim 1, wherein one of R² and R³ is (C₁-C₄)alkoxy or (C₁-C₄)alkyl, and the other is hydrogen.

18-19. (canceled)

20. The method according to claim 1, wherein:
R¹ is methyl or ethyl;
R² is hydrogen, (C₁-C₄)alkoxy, or (C₁-C₄)alkyl;
R³ is hydrogen, (C₁-C₄)alkoxy, or (C₁-C₄)alkyl;
R⁴ is hydrogen or methyl; and
R⁵ is selected from hydrogen and —C(═NH)NH₂.

21. The method according to claim 20, wherein:
R¹ is methyl or ethyl;
R² is hydrogen, —CH₃, —OCH₃, or —OCH₂CH₃;
R³ is hydrogen, —CH₃, —OCH₃, or —OCH₂CH₃; and
R⁴ is hydrogen or methyl.

22. (canceled)

23. The method according to claim 1, wherein said compound is selected from:

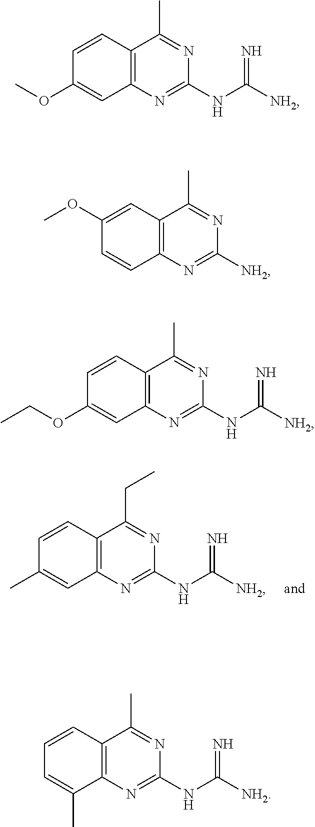 [SMILES: COc1ccc2c(C)nc(NC(=N)N)nc2c1 ; COc1ccc2nc(N)nc(C)c2c1 ; CCOc1ccc2c(C)nc(NC(=N)N)nc2c1 ; CCc1nc(NC(=N)N)nc2cc(C)ccc12 ; "and" ; Cc1nc(NC(=N)N)nc2c(C)cccc12]

24-28. (canceled)

29. The method according to claim 1, wherein said compound is selected from:

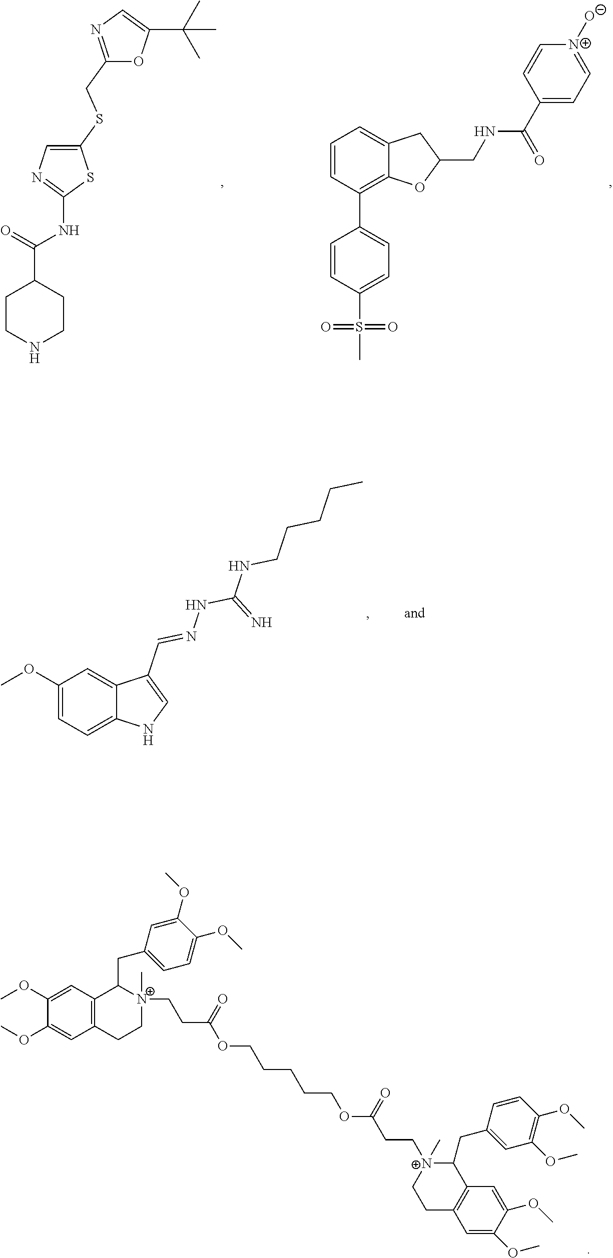

30-32. (canceled)

33. The method according to claim 1, wherein said blood-feeding arthropod is selected from a mosquito or a tick.

34. The method according to claim 1, wherein said blood-feeding arthropod is selected from Ae. Aegypti, Ae. albopictus, An. gambiae, Cu. quinquefasciatus, and Ix. scapularis.

35. The method according to claim 1, wherein said host is a human.

36. The method according to claim 1, wherein said providing an effective amount of a compound is accomplished by delivering said compound internally to a female mosquito through a method selected from field application; baiting traps with human odor; contact with the seminal fluid of transgenic males; soaking, spraying, injecting, feeding, introducing to through an aerosolized disbursement, introducing to through an environmental aerosolized disbursement, introducing to through an environmental aerosolized disbursement in water sources, brushing, dressing, dripping, or coating the mosquito.

37. An arthropod bait, wherein said bait comprises a compound selected from 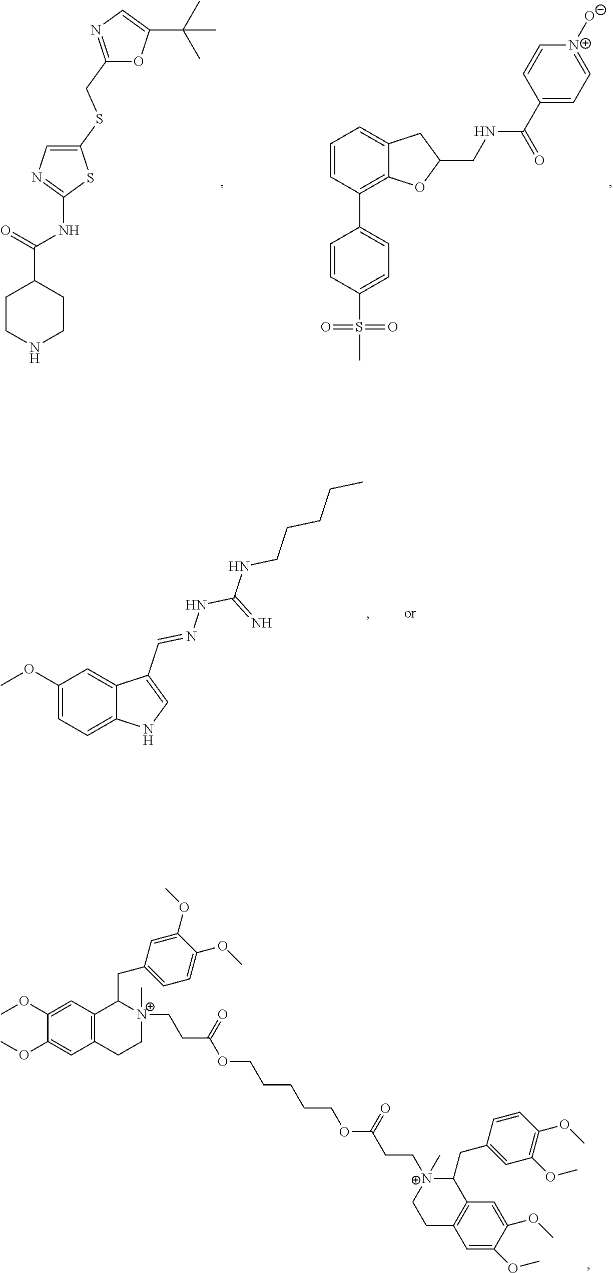
or a compound of formula I: 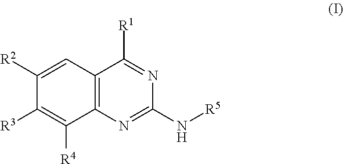
wherein
R¹ is selected from C₁-C₄alkyl;
R² is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;
R³ is selected from hydrogen, (C₁-C₄)alkoxy, (C₁-C₄)alkyl, fluoro, chloro, halo(C₁-C₄)alkyl, fluoro(C₁-C₄)alkoxy, amino, alkylamino, and dialkylamino;
R⁴ is selected from hydrogen and methyl;
R⁵ is selected from hydrogen, —C(═NH)NH₂, and —C(═NH)NHR⁶; and
R⁶ is (C₁-C₄)alkyl;
with the proviso that at least one of R², R³, and R⁴ is other than hydrogen.

38-40. (canceled)

41. A method of using an NPY agonist to inhibit host-seeking behavior in an arthropod.
